(19) United States
(12) Patent Application Publication
(10) Pub. No.: US 2015/0330376 A1
(43) Pub. Date: Nov. 19, 2015

(54) SWASH PLATE TYPE COMPRESSOR

(71) Applicant: Sanden Holdings Corporation, Isesaki-shi, Gunma (JP)

(72) Inventors: Norio TANIYAMA, Isesaki-shi, Gunma (JP); Takeo TOMITA, Isesaki-shi, Gunma (JP); Hiromitsu SHISHIDO, Isesaki-shi, Gunma (JP); Satoshi ANDO, Isesaki-shi, Gunma (JP)

(73) Assignee: Sanden Holdings Corporation, Isesaki-shi, Gunma (JP)

(21) Appl. No.: 14/654,842

(22) PCT Filed: Dec. 28, 2012
(86) PCT No.: PCT/JP2012/084229

§ 371 Date: Jun. 22, 2015

(51) Int. Cl. F04B 27/10

(52) U.S. Cl. CPC F04B 27/109; F05C 2251/14; F05C 2253/12; F05C 2253/20

(57) ABSTRACT

[Problem] In a swash plate of a swash plate type compressor, adhesion resistance of the swash plate will be greatly improved as compared with that achieved in the prior art by optimizing the average aspect ratio and the average particle size of the fluororesin particles contained in a lubrication film provided on the swash plate. [Solution] In a swash plate of a swash plate type compressor, a lubrication film composed of a binder resin, the fluororesin particles having an average aspect ratio of 1 to 1.5 and an average particle size of 7 to 13 micron-meters, and the graphite is provided at a sliding portion against a shoe of the swash plate.

### TECHNICAL FIELD

The present invention relates to a swash plate type compressor used in an air conditioner for vehicle or the like.

### BACKGROUND ART

A swash plate type compressor is classified into a fixed capacity swash plate type compressor in which a swash plate with tilt angle is directly fixed to a drive shaft rotatably disposed in a housing, and a variable capacity swash plate type compressor in which a swash plate with variable tilt angle and slidable is attached to the drive shaft through a connecting member. In both of the swash plate type compressors, the swash plate slides on a shoe and a rotation of the swash plate is converted into a reciprocal movement of a piston through the shoe to compress a refrigerant.

In the swash plate type compressors, as the swash plate slides along the shoe in an early stage of the operation before a lubricant contained in the refrigerant reaches the sliding portion, the sliding portion is made dry lubrication state without lubricant, and adhesion tends to occur. So, a lubrication film is provided on the sliding portion against a shoe of the swash plate for preventing adhesion in general. For example, Patent Document 1 discloses a lubrication film formed by coating a lubrication paint in which particles of fluororesin such as polytetrafluoroethylene (hereinafter referred to as “PTFE”) subjected to a surface treatment such as plasma treatment and have an average particle size of 0.01 to 20 micron-meters are dispersed in a binder resin composed of a polyamide imide resin on a swash plate substrate followed by drying. Patent Document 2 discloses a lubrication film formed by coating a. lubrication paint in which flattened particles of the fluororesin such as PTFE having an average particle size of 2 to 20 micron-meters and an average aspect ratio of 1.5 to 10 are dispersed in a binder resin such as a polyamide imide resin on a swash plate substrate followed by drying. Patent Document 3 discloses a lubrication film formed by coating a lubrication paint, in which particles of the fluororesin such as PTFE having an average particle size of 0.01 to 20 micron-meters are dispersed in a binder resin such as a polyamide imide resin on an outer circumferential surface of a piston skirt of an internal-combustion engine followed by drying.

Patent Document 1: Japanese Patent Laid-Open No. 2004-323594 (Columns [0012],[0035], and [0047] Patent Document 2: Japanese Patent Laid-Open No. 2005-187617 (Columns [0008], [0013], and [0015] Patent Document 3: Japanese Patent Laid-Open No, 2001-11372 (Columns [0010], [0012], and [0028]

### SUMMARY OF THE INVENTION

### Problems to be Solved

Depending on reduction in weight and size of the swash plate type compressor, requirement on higher speed and higher load progress require upgraded lubrication properties such as adhesion resistance. However, the numerical ranges of the average aspect ratio (the average ratio of a major axis/minor axis of each particle) and the average particle size of the fluororesin particles are not optimized in view of improving the lubrication properties such as adhesion resistance of the swash plate in the prior art. The fluororesin particles are pulverized and mixed by using a triple roll mill in Patent Document 1, the fluororesin particles are pulverized and mixed by using a bead mill in Patent Document 2, the fluororesin particles are pulverized and mixed by using a sand mill in Patent Document 3. That is, the fluororesin particles are crushed and mixed with large shearing force applied in any cases. So, the average aspect ratio and the average particle size of the fluororesin particles contained in the lubrication film may not be optimized in the prior art in view of improving the lubrication properties such as adhesion resistance of the swash plate.

The present invention has been accomplished in consideration of the circumstances of the prior art, and object of the present invention is to provide a swash plate type compressor improved in adhesion resistance of a swash plate by optimizing an average aspect ratio and an average particle size of the fluororesin particles contained in a lubrication film in view of improving lubrication properties such as adhesion resistance of the swash plate.

### Means to Solve the Problem

To solve the problem, the swash plate type compressor including a drive shaft rotatably disposed in a housing, a swash plate fixed directly to the drive shaft with a tilt angle or attached to the drive shaft via a connecting member with a variable tilt angle and rotate integrally with the drive shaft, a shoe disposed between the swash plate and a piston, and the piston reciprocating in a cylinder bore; and the swash plate type compressor converts rotational movement of the swash plate into reciprocating movement of the piston to compress a refrigerant; the construction of the swash plate type compressor characterized in that a lubrication film composed of a binder resin, the fluororesin particles having an average aspect ratio of 1 to 1.5 and an average particle size of 7 to 13 micron-meters, and the graphite is provided at a sliding portion against the shoe of the smash plate.

### Advantages of the Invention

According to the present invention, adhesion resistance of the swash plate is greatly improved in a swash plate of a swash plate type compressor as compared to the prior art by optimizing an average aspect ratio and an average particle size of the fluororesin particles contained in a lubrication film provided on the swash plate.

### BRIEF DESCRIPTION OF DRAWINGS

FIG. 1 is a cross-sectional view of a swash plate type compressor.

FIG. 2 is a perspective view of an assembled drive shaft, rotor, swash plate and link arm disposed in the swash plate type compressor.

FIG. 3 is a partial enlarged view of a sliding portion against the shoe of the swash plate.

### PREFERRED ENBODIMENTS OF THE INVENTION

A swash plate type compressor according to the embodiment of the present invention will be described.

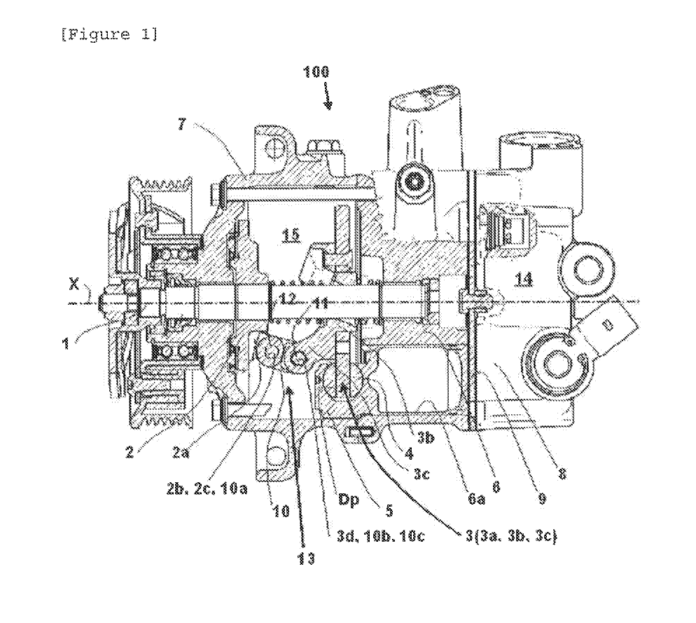

As shown in FIG. 1, the swash plate type compressor 100 is a variable capacity swash plate type compressor. The compressor 100 includes the drive shaft 1, the rotor 2 fixed on the drive shaft 1, and the swash plate 3 supported on the drive shaft 1 with variable tilt angle and slidable manner. The swash plate 3 includes the swash plate substrate 3a and the swash plate boss 3b, and the swash plate substrate 3a is fixed on the swash plate boss 3b with a rivet. A piston 5 caught with the swash plate 3 via a pair of shoes 4 sandwiching the peripheral portion of the swash plate 3 is slidably fit in a cylinder bore as 6a formed in a cylinder block 6. The drive shaft 1, the rotor 2 and the swash. plate 3 are housed in a front housing 7. An outlet chamber and an inlet chamber are provided in a cylinder head 8. The cylinder block 6 and the cylinder head 8 sandwich a valve plate 9. The cylinder block 6, the front housing 7, the cylinder head 8 and the valve plate 9 are integrally assembled. The drive shaft 1 is rotatably supported by the front housing 7 and the cylinder block 6.

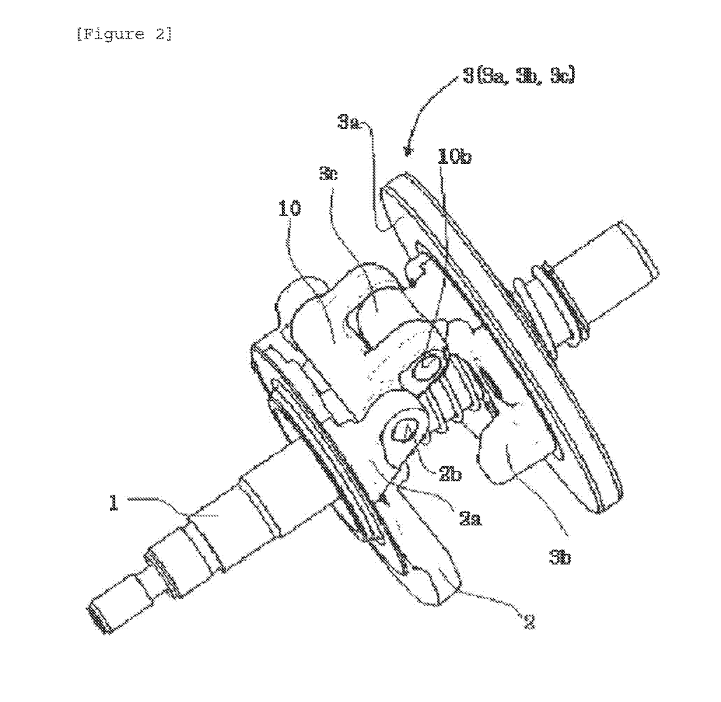

As shown in FIG. 1 and FIG. 2, circular through-holes 2b and 2c are formed in the pair of rotor arms 2a extending from the rotor 2 toward the swash plate 3. The circular through-holes 2b and 2c coaxially extend perpendicularly to a plane formed by the central axis line X of the drive shaft 1 and the top dead point Dp of the swash plate 3. The circular through-hole 3d is formed in a single swash plate arm 3c extending from the swash plate 3 toward the rotor 2. The circular through-hole 3d extends perpendicularly to the plane formed by the central axis line X of the drive shaft 1 and the top dead point Dp of the swash plate 3. The link arm 10 for linking the rotor arms 2a and the swash plate arm 3c is disposed. The circular through-hole 10a is formed in an end portion on one side of the link arm 10, and circular through-holes 10b and 10c are formed in forked end portions on. the other side of the link arm 10. The pair of rotor arms 2a sandwich the end portion on the one side of the link, arm 10, and the forked end portions on the other side of the link arm 10 sandwich the swash plate arm 3c.

The pin 11 is interlocked in the circular through-hole 3d with its both ends slidably fit in the circular through-holes 10b and 10c.The pin 12 is interlocked in the circular through-hole 10a with its both ends slidably fit in the circular through-holes 2b and 2c. The rotor arm 2a, the swash plate arm 3c, the link arm 10 and the pins 11 and 12 constitute the link mechanism 13. The link mechanism 1.3 links the rotor 2 and the swash plate 3 with each other not rotatably around the drive shaft 1 with allowing the tilt angle of the swash plate 3 variable.

In the swash plate type compressor 100, the drive shaft 1 is driven by an external driving source, the swash plate 3 rotates in accordance with the rotation of the drive shaft 1, and the piston 5 is driven to reciprocate by the swash plate 3 via the shoes 4. A refrigerant gas reflow from an external refrigerant circuit to the compressor 100 flows into the inlet chamber 14 through an inlet port, introduced into the cylinder bore 6a through an inlet hole and an inlet valve formed in the valve plate 9. Then the refrigerant gas is compressed under pressure by the piston 5 and discharged via an outlet hole and an outlet valve formed in the valve plate 9 to the outlet chamber, and reflows via an outlet port to the external refrigerant circuit. Note that the tilt angle of the swash plate 3 is controlled by a control system not shown by controlling a pressure difference between the pressures in the inlet, chamber 14 and the crank chamber 15 by a pressure difference control valve in accordance with the thermal load on the air conditioner,

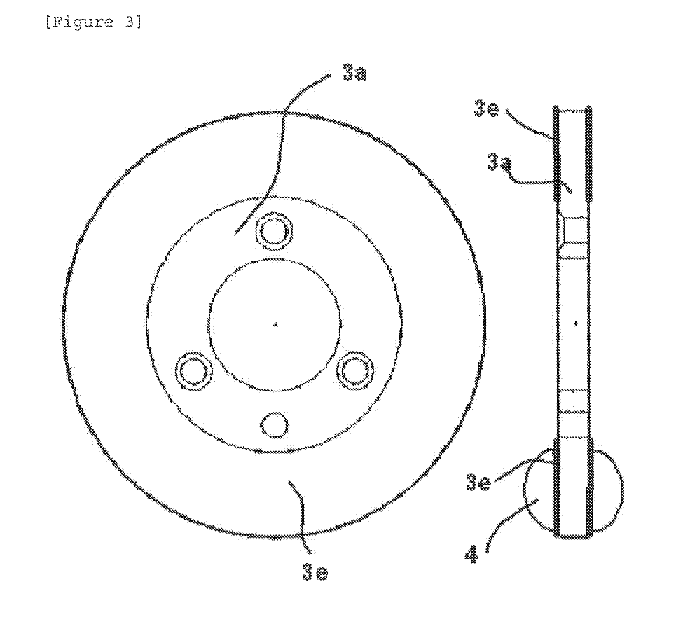

As shown in FIG. 3, a lubrication film 3e of a lubrication paint is formed on a sliding portion against each shoe 4 of the swash plate substrate 3a. The lubrication film 3e is composed of a binder resin, the fluororesin particles having an average aspect ratio of 1 to 1.5 and an average particle size of 7 to 13 micron-meters, and the graphite. In the present invention, the term “aspect ratio” of the fluororesin particles represents ratio of a major axis/minor axis in the particle, the term “average aspect ratio” represents an average of the aspect ratios of a prescribed number (10,000) of the fluororesin particles.

As the binder resin, at least one of thermosetting resins including a polyamide imide resin, a polyimide resin, a polyether imide resin, a phenol resin, an epoxy resin, and unsaturated polyester may be used, and one containing a polyamide imide resin as a main component is preferable. In particular, a thermosetting resin composition containing 2 to 18 parts by weight of an epoxy resin against 100 parts by weight of a polyamide imide resin is preferable as the binder resin. If such thermosetting resin composition is employed, a lubrication film having an excellent adhesion resistance may be provided. As the epoxy resin, aromatic epoxy resins such as bisphenol -A. epoxy resin, bisphenol B epoxy resin, bisphenol F epoxy resin, biphenyl epoxy resin, and novolac epoxy resin may be used, and in particular, bisphenol-A epoxy resin in a liquid form at normal temperature is preferable.

If a polyamide imide resin mixed with an aromatic epoxy resin is used as the binder resin, adhesion resistance of the swash plate 3 provided with the lubrication film 3e has a relationship to show the maximum with content of the aromatic epoxy resin, and adhesion resistance is the maximum if content is approximately 5%. If content is less than 2%, no significant difference may be achieved as compared to the case without the aromatic epoxy resin. If content exceeds 18%, adhesion resistance is equivalent to or less than the case without the aromatic epoxy resin.

As the fluororesin particles, the particles of at least one of fluororesins such as PTFE, a perfluoroethylene-hexafluoropropylene copolymer, a tetrafluoroethylene-perfluoroalkyl vinyl ether copolymer, and a tetrafluoroethylene-ethylene copolymer may be used. Among these, PTFE resin powder is preferable to be used. PTFE resin has a. melt viscosity at about 340 to 380 deg.-C. is high as about 1010 to 1011 Pa-s, is difficult to flow at a temperature beyond the melting point, shows the best heat resistance among the fluororesin, and is excellent in the wear resistance.

As bonding force of the fluororesin particles to a binder resin is generally weak, the fluororesin particles may separate at the boundary surface with the binder resin due to frictional force and applied load caused through the sliding of the swash plate against the shoe and drop off from the lubrication film 3e. As a result, adhesion easily cause at a portion from where the fluororesin particles drop off. In the present invention, the fluororesin particles are prevented from peeling/dropping off from the lubrication film as much as possible to improve adhesion resistance of the swash plate because the fluororesin particles contained in the lubrication film 3e controls average aspect ratio to be 1 to 1.5 and average particle size to be 7 to 13 micron-meters. If the average aspect ratio of the fluororesin particles are larger than 1.5, or if the average particle size of the fluororesin particles are smaller than 7 micron-meters, the surface area (specific surface area) per unit weight of the fluororesin particles are too large. As a result, the surface area of a portion having a weak adhesion between the fluororesin particles and the binder resin is too large, and the fluororesin particles easily drop off from the lubrication film 3e to easily cause the adhesion. If the average particle size of the fluororesin particles are greater than 13 micron-meters, the contact area between the swash plate substrate and the binder resin is reduced to lower the bonding force of the lubrication film to easily cause the adhesion.

Adhesion resistance (time for adhesion) of the swash plate 3 provided with the lubrication film 3e has relationship to show the maximum with the average particle size of the fluororesin particles if the fluororesin particles has an average aspect ratio of 1 to 1.5 and an average particle size of 7 to 13 micron-meters, and adhesion resistance is the maximum at average particle size of approximately 10 micron-meters.

The fluororesin particles lowers the friction coefficient of the lubrication film 3e under high-speed sliding conditions to prevent wear and ablation at the lubrication film surface. If content of the fluororesin particles increase, the friction coefficient decreases. However, if content of the fluororesin particles are too large, the hardness of the lubrication. film decreases and wear increases to cause peeling off of the lubrication film. So, content of the fluororesin particles are preferable to be 40 to 70 parts by weight and more preferable to be 50 to 60 parts by weight against 100 parts by weight of the binder resin.

As the graphite, either of natural graphite and artificial graphite may be used. Although shape of the graphite include scaly, amorphous, massive, flaky and spherical, the graphite in any shapes may be used. The average particle size of the graphite is preferable to be 1 to 15 micron-meters and more preferable to be 1 to 5 micron-meters. Graphite increases the abrasion resistance of the lubrication film 3e, but if content of the graphite increase, the friction coefficient increases. So, content of the graphite is preferable to be 1 to 20 parts by weight and more preferable to be 5 to 15 parts by weight against 100 parts by weight of the binder resin.

The lubrication paint can be prepared by mixing and dispersing a composition composed of the binder resin, the fluororesin particles and the graphite in prescribed ratios together with a proper amount of an organic solvent. As the organic solvent, a high-boiling point polar solvent having good dissolubility of the binder resin, such as N-methylpyrrolidone, 2-pyrrolidone, methylisopyrrolidone, dimethylformamide, or dimethylacetamide; an aromatic solvent such as toluene or xylene; a ketone such as acetone or methyl ethyl ketone; an ester such as methyl acetate or ethyl acetate; or a. mixed solvent, of any of these is generally used.

Even if the fluororesin particles having an average aspect ratio of 1 to 1.5 and an average particle size of 7 to 13 micron-meters is used as a raw material of the coating paint, the average aspect ratio and the average particle size of the fluororesin particles may change beyond the ranges if shearing force as large as to pulverize the particle is applied in preparation of the lubrication paint. The average aspect ratio of 1 to 1.5 and the average particle size of 7 to 13 micron-meters in the fluororesin particles contained in the prepared lubrication paint should be kept. Therefore, as a mixing/dispersing machine used in preparation of the coating paint, one not pulverizing the fluororesin particles including a propeller agitator, a magnetic stirrer, or a planetary centrifugal mixer is suitable.

The swash plate substrate 3a is subjected to a degreasing before coating the lubrication paint. After the degreasing, the swash plate substrate 3a is preferable to be subjected to a roughening treatment by shot blasting to adjust the surface roughness in Rzjis of the substrate to be 8.0 to 13.0 micron-meters. Adhesion resistance (time for adhesion) shows the maximum in relationship with the surface roughness of the swash plate substrate if the surface roughness is in the range. If the surface roughness in Rzjis is less than 8.0 micron-meters, the load for adhesion resistance decreases, and if the surface roughness in Rzjis exceeds 13.0 micron-meters, the lubrication film 3e wear away at a projected portion of rough surface and expose the base metal of the swash plate substrate 3a to result tendency that the adhesion easily occur.

The lubrication film 3e can be formed by coating the lubrication paint on a swash plate substrate 3a subjected the treatment to make a dried film thickness of 35 to 70 micron-meters followed by thermally curing the coated film at 180 to 270 deg.-C. for 15 to 80 minutes. Then, grinding of the cured film by a grinder is carried out to adjust the surface roughness in Ra to be 0.6 to 1.6 micron-meters. As a method for curing by heating, just hot air may be applicable, but it is more preferable to use hot air and far infrared radiation in combination. As the swash plate substrate 3a, an iron-based, copper-based or aluminum-based substrate may be used, but an iron-based substrate is generally used.

EXAMPLES

The following tests were carried out to investigate influence of the average aspect ratio and the average particle size of the fluororesin particles contained in a binder resin on adhesion resistance. Components for film formation to finish the composition shown in Table 1 and proper amount of an organic solvent. (N-methylpyrrolidone) were stirred and mixed by using a propeller agitator to prepare a lubrication paint in Examples. On the other hand, Components for film formation to finish the composition shown in Table 1 and a proper amount of an organic solvent (N-methylpyrrolidone) were pulverized and mixed by using a bead mill to prepare a lubrication paint in Comparative Examples. Swash plate substrates made of steel were subjected to a degreasing, followed by roughening the surface by shot blasting to adjust the surface roughness in Rzjis to be 9.0 micron-meters. Lubrication paint was coated on the surface of the swash plate substrate to make a dried film thickness 50 micron-meters, and the dried film was cured by heating at 230 deg.-C. for 30 minutes. Then, the cured film was ground by using a grinder to make the surface smooth. Finished lubrication film has surface roughness in Ra of 0.8 micron-meters. The average particle size of the graphite was 4 to 5 micron-meters.

Swash plate substrates provided with the lubrication films was subjected to a lubrication performance test under the following test conditions:

Test conditions

Test machine: Rotary friction abrasion test machine

Lubrication: Dry lubrication

Load: 8.8 MPa

Speed: 2000 rpm

Counter shaft: SUJ2 (in shoe shape)

The test results are as follows.

| | | PTFE particles contained in | | | | | | |
|---|---|---|---|---|---|---|---|---|
| | | coating paint prepared | | | | | | Test result |
| | | | Average | Composition ratio | | | | Time for |
| | | Average | particle size | (in weight) | | | | adhesion |
| | | aspect ratio | (micron-meters) | PAI | BPER | Gr | PTFE | (sec) |
| Ex- | 1 | 1.34 | 7.2 | 100 | 5 | 10 | 55 | 397 |
| ample | 2 | 1.37 | 9.9 | 100 | 5 | 10 | 55 | 408 |
| | 3 | 1.35 | 12.9 | 100 | 5 | 10 | 55 | 383 |
| Compar- | 1 | 1.30 | 1.5 | 100 | 5 | 10 | 55 | 256 |
| ative Ex- | 2 | 1.37 | 20.1 | 100 | 5 | 10 | 55 | 232 |
| ample | 3 | 2.01 | 9.8 | 100 | 5 | 10 | 55 | 257 |

Components for film formation shown in the table:
PAI: Polyamide imide resin (HPC-6000 series manufactured by Hitachi Chemical Company, Ltd)
BPER: Bisphenol-A epoxy resin (in a liquid. form at 25 deg. -C.) (EPICLON 850 manufactured by DIC Corporation)
PTFE particle: Polytetrafluoroethylene (KTL series manufactured by KITAMURA LIMITED)
Gr: Graphite (CSSP manufactured by Nippon Graphite Industries, Co., Ltd.)

Measurement methods of aspect ratio and particle size of PTFE particles shown in the table.
Measurement method: of aspect ratio:
   Aspect of the particle was measured by using a dynamic image analysis/particle analyzer (PITA-3 manufactured by Seishin Enterprise Co., Ltd.).
Measurement method of particle size:
   Particle size of particles in a volume ratio of 50% was measured by using a laser diffraction scattering particle size distribution analyzer (Microtrac manufactured by NIKKISO CO., LTD.).

In view of the test results, adhesion time is the longest if PTFE particles having an average particle size of 10 micron-meters is used, and adhesion time is longer if PTFE particles having a particle size of 7 to 13 micron-meters is used than if PTFE particles having a particle size of 4 micron-meters or 20 micron-meters is used.

Following tests were carried out to investigate influence of the number average molecular weight of PTFE particles contained in a binder resin on adhesion resistance. Components for film formation to finish the composition shown in Table 2 and a proper amount of an organic solvent (N-methylpyrrolidone) were stirred and mixed by using a propeller agitator to prepare a lubrication paint in Examples. Swash plate substrates made of steel were subjected to a degreasing, followed by roughening the surface by shot blasting to adjust the surface roughness in Rzjis to be 8.5 micron-meters, Lubrication paint was coated on the surface of the swash plate substrate to make a dried film thickness 60 micron-meters, and the dried film was cured by heating at 230 deg.-C. for 30 minutes. Then, the cured film was ground by using a grinder to make the surface smooth. Finished lubrication film has surface roughness in Ra of 0.8 micron-meters.

Swash plate substrates provided with the lubrication films was subjected to a lubrication performance test under the following test conditions:

Test conditions

Test machine: Rotary friction abrasion test machine

Lubrication: Dry lubrication

Load: 8.8 MPa

Speed: 2000 rpm

Counter shaft: SUJ2 (in shoe shape)

The test results are as follows.

| | | PTFE particles | | | | | | Test result |
|---|---|---|---|---|---|---|---|---|
| | | Number average | Particle size | Composition ratio | | | | Time for |
| | | molecular | (micron-meters)/ | (in weight) | | | | adhesion |
| | | weight | Aspect ratio | PAI | BPER | Gr | PTFE | (sec) |
| Ex- | 4 | 40000 | 9.9/1.37 | 100 | 5 | 10 | 55 | 408 |
| ample | 5 | 100000 | 10.1/1.31 | 100 | 5 | 10 | 55 | 385 |
| | 6 | 200000 | 10.8/1.38 | 100 | 5 | 10 | 55 | 295 |

Components for film formation shown in the table.
PAI: Polyamide imide resin (HPC-6000 series manufactured by Hitachi Chemical Company, Ltd,)
BPER: Bisphenol-A epoxy resin (in a liguid form at 25 deg.-C.) (EPICRON 850 manufactured by DIC Corporation)
PTFE particle: Polytetrafluoroethylene (KTL series manufactured by KITAMURA LIMITED)
Gr: Graphite (CSSP manufactured by Nippon Graphite Industries, Co., Ltd.)
Measurement method of number average molecular weight (Mn) of PTFE particle:
   Measured by gel permeation chromatography (GPC) using a calibration curve of standard polystyrene.
Measurement method of shape of PTFE particle:
   Aspect of the particle was measured by using a dynamic image analysis/particle analyzer (PITA-3 manufactured by Seishin Enterprise Co., Ltd.).
Measurement method of particle size:

Particle size of particles in. a volume ratio of 50% was measured by using a laser diffraction scattering particle size distribution analyzer (Microtrac manufactured. by NIKKISO CO., LTD.).

In view of the test results, adhesion time is longer if PTFE particles having a number average molecular weight of 100,000 or less is used than if PTFE particles having a number average molecular weight exceeding 100,000 is used.

Following tests were carried out to investigate influence of the specific surface area of the graphite on adhesion resistance. Components for film formation to finish the composition shown in Table 3 and a proper amount of an organic solvent. (N-methylpyrrolidone) were stirred and mixed by using a propeller agitator to prepare lubrication paint in Examples. The average particle size of the PTFE particles was 10 micron-meters, and the aspect ratio was 1,3. Swash plate substrates made of steel were subjected to degreasing, followed by roughening the surface by shot blasting to adjust the surface roughness in. Rzjis to be 8.5 micron-meters, Lubrication paints were coated on the surface of the swash. plate substrate to make a dried film thickness 60 micron-meters, and the dried film was cured by heating at 230 deg.-C. for 30 minutes, Then, the cured film was ground by using a grinder to make the surface smooth. Finished lubrication film has surface roughness in Ra of 0.8 micron-meters,

Swash plate substrates provided with the lubrication films were subjected to a lubrication performance test under the following test conditions:

Test conditions

Test machine: Rotary friction abrasion test machine

Lubrication: Dry lubrication

Load: 8.8 MPa

Speed: 2000 rpm

Counter shaft; SUJ2 (in shoe shape)

The test results are as follows.

| | | Graphite | | | | | | Test result |
|---|---|---|---|---|---|---|---|---|
| | | Average | Specific | Composition ratio | | | | Time for |
| | | particle size | surface area | (in weight) | | | | adhesion |
| | | (micron-meters) | (m²/g) | PAI | BPER | Gr | PTFE | (sec) |
| Ex- | 7 | 4.7 | 110 | 100 | 5 | 10 | 55 | 374 |
| ample | 8 | 4.7 | 245 | 100 | 5 | 10 | 55 | 408 |
| | 9 | 4.6 | 13 | 100 | 5 | 10 | 55 | 301 |

Components for film formation shown in the table.
PAI: Polvamide imide resin (HPC-6000 series manufactured by Hitachi Chemical Company, Ltd.)
BPER: Bisphenol-A epoxy resin (in a liquid form at 25 deg.-C.) (EPICRON 850 manufactured by DIC Corporation)
PTFE particle: Polytetrafluoroethylene (KTL-10N manufactured by KITAMURA LIMITED)

Gr: Graphite (CSSP (245 m2/g) , UCP (110 m2/g), J-CPB (13 m2/g) manufactured by Nippon Graphite Industries, Co., Ltd.)
Measurement method of specific surface area of the graphite:

Measured by a nitrogen adsorption method (BET method) using a flow-type specific surface area automatic measuring apparatus (FlowSorb III 2305/2310 manufactured by SHIMADZU CORPORATION).
Measurement method of particle size:

Particle size of particles in a volume ratio of 50% was measured by using a laser diffraction scattering particle size distribution analyzer (Microtrac manufactured by NIKKISO CO., LTD.),

In view of the test results, adhesion time is longer if the graphite having specific surface area of 100 or more is used than if the graphite having specific surface area of less than 100 is used.

Following tests were carried out to investigate the influence of content of the aromatic epoxy resin against content of the polyamide imide resin in the binder resin on adhesion resistance. Components for film formation to finish the composition shown in Table 4 was stirred and mixed by using a propeller agitator to prepare a lubrication paint.. Swash plate substrates made of steel were subjected to a degreasing, followed by roughening the surface by shot blasting to adjust the surface roughness in Rzjis to be 9.0 micron-meters, Lubrication paints were coated on the surface of the swash plate substrate to make a dried film thickness 60 micron-meters, and the dried. film was cured. by heating at 230 deg. -C. for 30 minutes. Then, the cured film was ground by using a grinder to make the surface smooth. Finished lubrication film has surface roughness in Ra of 0.8 micron-meters. The average particle size of PTFE was 10 micron-meters (aspect ratio is 1.3), and the average particle size of the graphite was 4 to 5 micron-meters.

Swash plate substrates provided with the lubrication films were subjected to a lubrication performance test under the following test conditions.

Test conditions

Test machine: Rotary friction. abrasion test machine

Lubrication: Dry lubrication

Load: 8.8 MPa

Speed: 2000 rpm

Counter shaft: SUJ2 (in shoe shape)

The test results are as follows.

| | Test result |
|---|---|
| Composition ratio | Time for |
| (in weight) | adhesion |

| | | PAI | BPER | PTFE | Gr | (sec) |
|---|---|---|---|---|---|---|
| Ex- | 10 | 100 | 2 | 50 | 5 | 296 |
| ample | 11 | 100 | 5 | 50 | 5 | 379 |
| | 12 | 100 | 10 | 50 | 5 | 364 |
| | 13 | 100 | 15 | 50 | 5 | 323 |
| | 14 | 100 | 18 | 50 | 5 | 298 |
| | 15 | 100 | 5 | 30 | 5 | 295 |
| | 16 | 100 | 5 | 40 | 5 | 356 |
| | 17 | 100 | 5 | 55 | 5 | 375 |
| | 18 | 100 | 5 | 60 | 5 | 385 |
| | 19 | 100 | 5 | 70 | 5 | 337 |
| | 20 | 100 | 5 | 80 | 5 | 308 |
| | 21 | 100 | 5 | 55 | 0 | 292 |
| | 22 | 100 | 5 | 55 | 1 | 322 |
| | 23 | 100 | 5 | 55 | 10 | 408 |
| | 24 | 100 | 5 | 55 | 15 | 390 |
| | 25 | 100 | 5 | 55 | 20 | 355 |
| | 26 | 100 | 5 | 55 | 25 | 295 |
| | 27 | 100 | 0 | 50 | 5 | 270 |
| | 28 | 100 | 1 | 50 | 5 | 273 |
| | 29 | 100 | 20 | 50 | 5 | 268 |

PAI: Polyamide imide resin (HPC-6000 series manufactured by Hitachi Chemical Company, Ltd.)
BPER: Bisphenol-A epoxy resin (in a liquid form at 25 deg.-C.) (EPICRON 850 manufactured by DIC Corporation)
PTFE: Polytetrafluoroethylene (KTL-10N manufactured by KITAMURA LIMITED)
Gr: Graphite (CSSP manufactured by Nippon Graphite Industries, Co., Ltd.)

In view of the test results, adhesion time is the longest if content of the bisphenol-A epoxy resin is 5 parts by weight against 100 parts by weight of the polyamide imide resin. If content of the bisphenol-A epoxy resin is 2 to 18 parts by weight, adhesion time is longer than the case without bisphenol-A epoxy resin. If content is less than 2 parts by weight or exceeding 18 parts by weight, however, adhesion time is equivalent to or less than the case without bisphenol-A epoxy resin. If content of the PTFE is 50 to 60 parts by weight and content of the graphite is 5 to 15 parts by weight against 100 parts by weight of the polyamide imide resin, good adhesion resistance is achieved. If content of the PTFE is less than 40 parts by weight or exceeding 70 parts by weight, or if content of the graphite is less than 1 part by weight or exceeding 20 parts by weight, adhesion time is short.

### INDUSTRIAL APPLICABILITY

The swash plate type compressor according to the present invention is industrially useful because adhesion resistance of a swash plate is greatly improved as compared with that achieved by the prior art because the average aspect ratio and the average particle size of the fluororesin particles contained in a lubrication film provided on the swash plate is optimized.

### SYMBOL LIST

1 drive shaft

2 rotor

2a rotor arm

2b, 2c circular through-hole

3 swash plate

3a swash plate substrate

3b swash plate boss

3c swash plate arm

3d circular through-hole

3e lubrication film

4 shoe

5 piston

6 cylinder block

6a cylinder bore

7 front housing

8 cylinder head

9 valve plate

10 link arm

10a, 10b, 10c circular through-hole

11, 12 pin

13 link mechanism

14 inlet chamber

15 crank chamber

1. A swash plate type compressor including a drive shaft rotatably disposed in a housing, a swash plate fixed directly to the drive shaft with a tilt angle or attached to the drive shaft via a connecting member with a variable tilt angle and rotate integrally with the drive shaft, a shoe disposed between the swash plate and a piston, and the piston reciprocating in a cylinder bore; and the swash plate type compressor converts rotational movement of the swash plate into reciprocating movement of the piston to compress a refrigerant; wherein a lubrication film composed of a binder resin, fluororesin particles having an average aspect ratio of 1 to 1.5 and an average particle size of 7 to 13 micron-meters, and the graphite is provided at a sliding portion against the shoe of the swash plate.

2. The swash plate type compressor according to claim 1, wherein the fluororesin particles has a number average molecular weight of 100,000 or less.

3. The swash plate type compressor according to claim 1, wherein the graphite has a specific surface area of 100 m2/g or more.

4. The swash plate type compressor according to claim 1, wherein the binder resin is a thermosetting resin composed of a polyamide imide resin and an aromatic epoxy resin.

5. The swash plate type compressor according to claim 1 wherein the binder resin is a thermosetting resin composed of 100 parts by weight of a polyamide imide resin and 2 to 18 parts by weight of an aromatic epoxy resin.

6. The swash plate type compressor according claim 1, wherein the aromatic epoxy resin is bisphenol-A epoxy resin.

7. The swash plate type compressor according to claim 1, wherein the lubrication film contains 100 parts by weight of the binder resin, 40 to 70 parts by weight of the fluororesin particles, and 1 to 20 parts by weight of the graphite.
